(19) United States
(12) Patent Application Publication
(10) Pub. No.: US 2007/0222122 A1
(43) Pub. Date: Sep. 27, 2007

(54) Brightened composite sheel and method for making the same

(76) Inventors: Ching-Long Ong, Taichung City (TW); Chia-Tung Yen, Taichung City (TW); Jun-Hao Young, Taichung City (TW); Diing-Guey Hwang, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/386,728

(22) Filed: Mar. 23, 2006

(51) Int. Cl. B29C 70/44

(52) U.S. Cl. 264/510; 264/571; 264/257; 264/553

(57) ABSTRACT

A method for fabricating a brightened composite shell includes step of (a): providing an uncured composite material on a surface of a metallic mold; step (b): curing the composite material by vacuum molding to form a consolidated composite embryo via the vacuum molding process; and step (c): machining the cured composite embryo so as to fabricate the final brightened shell shape. The present invention employs non-painting method and provides a brightened composite shell having a smooth and stereo surface without blisters and pin-holes being generated thereon.

### FIELD OF THE INVENTION

The present invention relates to a brightened composite shell and a method for fabricating the same without blisters and pin-holes.

### BACKGROUND OF THE INVENTION

Products with a hard casing are used in a multiple variety of fields such as the case of computers, cellular phones, laptops, or suitcases. Generally, the hard cases can be made by plastic or metallic material such as Aluminum alloy or Magnesium alloy. The plastic casing can be made by way of injection molding and in order to obtain a thin and sophisticate casing, a more complicated method is developed to inject the plastic material. However, the complicated method is costly and the thin plastic casing has less structural strength so that it is easily to be broken.

The metallic casings are heavy and involve high-cost molds. Both of the plastic and metallic casings have to be coated with an outer protection layer to display its surface quality.

Another method uses a method of press molding to laminate multiple layers of composite material and the products are light and have better structural strength. Nevertheless, the casing needs to be coated with a transparent resin to have a bright and smooth outer surface. Besides, there are blisters or pin-holes generated during the processes of the method so that extra careful steps are taken to remove these blisters and pin-holes.

The present invention intends to provide a method for fabricating a brightened composite shell by way of vacuum molding and blisters and pin-holes are generated so that the products have stereo surfaces no generally coating processes.

### SUMMARY OF THE INVENTION

The present invention relates to a shell with a brightened surface and the shell is made by the following steps which are:

step (a): providing an uncured composite material on a surface of a metallic mold, the composite material comprising lamination of pre-preg of matrix resin and fibers, a weight ratio of the matrix reins in the composite material being 30% to 60%;

step (b): curing the composite material by vacuum molding to form a semi-product; and

step (c): machining the cured composite semi-product by removing surplus material to become a final product.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a flow chart of the steps of the method of the present invention;

FIG. 2 is a cross sectional view of the shell made by the method of the present invention;

FIG. 3 is a part of a case of a computer made by the method of the present invention, and

FIG. 4 shows different patterns or labels are used to decorate the shell of the present invention.

### DETAILED DESCRIPTION OF THE PREFERRED EMBODIMENT

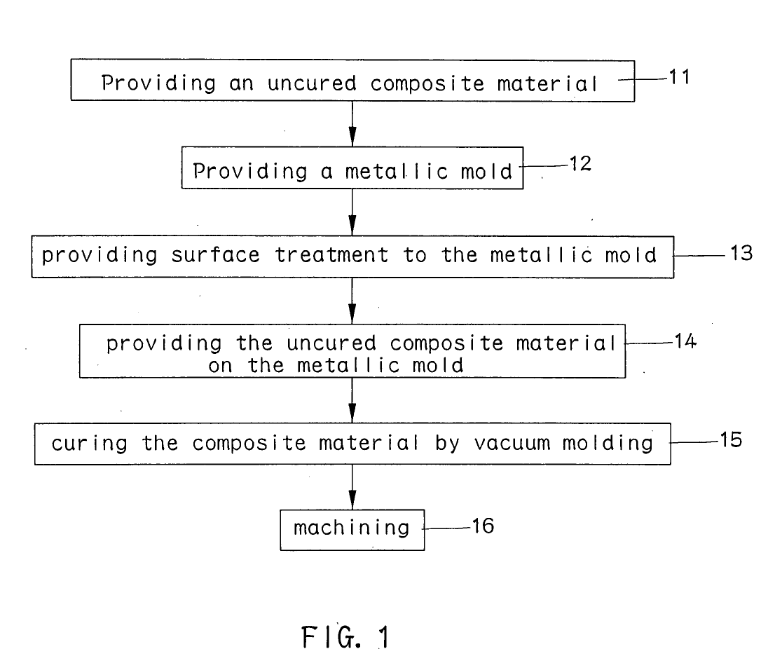

Referring to FIG. 1, the method of the present invention comprises the following steps:

a step 11 of providing an uncured composite material 11;

a step 12 of providing a metallic mold;

a step 13 of providing surface treatment to the metallic mold;

a step 14 of providing the uncured composite, material 11 on the metallic mold;

a step 15 of curing the composite material by vacuum molding to form a consolidated semi-product, and a step 16 of machining by removing surplus material to become a final product.

The composite material can be one of a carbon-fiber composite material, a KEVLAR fiber composite material, a glass-fiber composite material, a dyed-fiber composite material and a hybrid-fiber composite material.

The composite material includes multiple laminations of pre-preg of matrix resin and fibers, a weight ratio of the matrix reins in the composite material being 30% to 60%. The contents of the matrix resin is one or two times of general pre-preg material. The matrix resin of the composite material is chosen from one of a thermosetting resin and a thermoplastic resin. The way of weaving of the fibers can be one of a unidirectional weave, a plain weave, a satin weave, a twill weave and a multi-axial weave.

The composite material is cut into proper sizes before being put on the metallic mold and the composite material and the metallic mold are sealed by using a sealing member.

The metallic mold is treated by a surface treatment to obtain a polished mold with a fine and smooth surface. The surface treatment includes a surface polish process and a surface hardening process. The surface polish process is one of the following methods which are mechanical polishing, chemical polishing, chemical-mechanical polishing (CMP). The surface hardening process can be one of the following treatments which are a surface chrome coating process, a surface titanium coating process, a surface carburizing process and a surface nitrogenzing process. The uncured composite material is then put on the metallic surface that is treated.

The vacuum molding is done by a vacuum appliance which can be one of the following devices which are an autoclave, an oven and a pump. The vacuum molding is to seal the composite material by using a seal member and the composite material is heated in a temperature between 0 to 1600 degrees Celsius under a pressure between 0 to 100 atmospheric pressure.

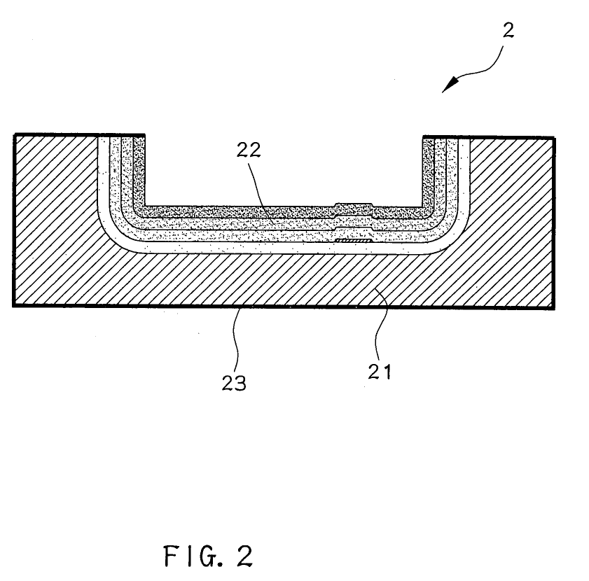

As shown in FIG. 2, the metallic mold 21 used with the vacuum appliance 2 is polished to have a fine and smooth surface and the treatment can be a surface chrome coating process, a surface titanium coating process, a surface carburizing process or a surface nitrogenizing process. A releasing agent is applied to the surface of the metallic mold 21 so as to easily separate the semi-product and the mold.

The composite material 22 is then laminated on the metallic mold 21 at a proper angle. A seal member 23 is used to seal the metallic mold 21 and the composite material 22, and the sealed pack is sent to the vacuum appliance 2 to check the reliability of the sealing by the seal member 23.

The sealed pack of the composite material 22 is then laminated on the metallic mold 21 is sent into an oven or an autoclave to cure or consolidate. By proper setting of the temperature and pressure, the seal member 23 is removed and the semi-product is then machined to remove the surplus material to form the final product which has a brightened surface.

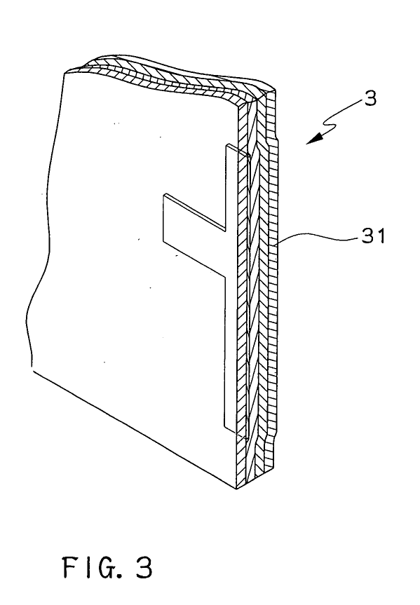

As shown in FIG. 3, the shell made by the method of the present invention uses three to five layers of plain weave carbon fiber fabric or multiple layers of satin weave of KEVELAR/Epoxy pre-preg 31. The pre-preg 31 is cured by using an autoclave. The composite material for making computer casings 3 is heated at 110 to 150 degrees Celsius under 2 to 20 atmospheric pressure. The composite material includes high ratio of resin so that the pre-preg 31 is cured on the metallic mold 21 and forms a bright surface 310 which is directly formed by the reins so that no painting or coating is needed. Due to the vacuum treatment and high pressure, there are no blisters and pin-holes generated, and the bright surface 310 has stereo surface which meets requirement for the casing of laptops in the market.

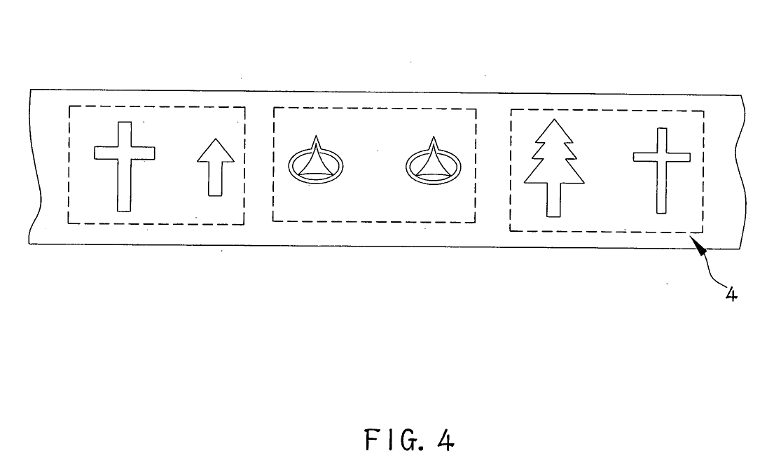

As shown in FIG. 4, another embodiment uses multiple layers of prepreg and different patterns or labels 4 are put in the final products. The composite material for making electronic appliance casings is heated at 110 to 150 degrees Celsius for two hours. The final products have a bright surface and no painting or coating is needed. There are no blisters and pin-holes generated, and the bright surface 310 has stereo surface which meets requirement for the casing of laptops in the market.

As shown in FIG. 3, the patterns or labels 5 are put in the metallic mold and laminated with the composite material. The patterns or labels 5 is in a form of prepreg resin and the surfaces of the patterns or labels 5 are combined with the surfaces of the prepreg 31 so a to form a bright surface 3 10. The patterns or labels 5 can be made by plastic material or metallic material, and the resin of the composite material flows to an outer surface of the patterns or labels 5 to form the bright surface.

While we have shown and described the embodiment in accordance with the present invention, it should be clear to those skilled in the art that further embodiments may be made without departing from the scope of the present invention.

What is claimed is:

1. A method for fabricating a shell, comprising:
step (a): providing an uncured composite material on a surface of a metallic mold, the composite material comprising lamination of prepreg of matrix resin and fibers, a weight ratio of the matrix reins in the composite material being 30% to 60%;
step (b): curing the composite material by vacuum molding to form a semi-product; and
step (c): machining the cured composite semi-product by removing surplus material to become a final product.

2. The method as claimed in claim 1, wherein the composite material is chosen from one of a carbon-fiber composite material, a KEVLER fiber composite material, a glass-fiber composite material, a dyed-fiber composite material and a hybrid-fiber composite material.

3. The method as claimed in claim 1, wherein the composite material includes a matrix resin and fibers, the composite material is used by way of pre-preg and wet lay-up.

4. The method as claimed in claim 3, wherein the matrix resin is chosen from one of a thermosetting resin and a thermoplastic resin.

5. The method as claimed in claim 3, wherein the pre-preg is woven by one of a unidirectional weave, a plain weave, a satin weave, a twill weave and a multi-axial weave.

6. The method as claimed in claim 1, wherein the surface of the metallic surface is treated by a surface treatment.

7. The method as claimed in claim 6, wherein the surface treatment is a surface polish process to form a polished mold.

8. The method as claimed in claim 7, wherein the surface polish is one of the following methods which are mechanical polishing, chemical polishing, chemical-mechanical polishing (CMP).

9. The method as claimed in claim 6, wherein the surface treatment is a surface hardening process.

10. The method as claimed in claim 9, wherein the surface hardening process is one of the following treatments which are a surface chrome coating process, a surface titanium coating process, a surface carburizing process and a surface nitrogenizing process.

11. The method as claimed in claim 1, wherein the vacuum molding is done by a vacuum appliance.

12. The method as claimed in claim 11, wherein the vacuum appliance is one of the following devices which are an autoclave, an oven and a pump.

13. The method as claimed in claim 1, wherein the vacuum molding is to seal the composite material which is heated in a temperature between 0 to 1600 degrees Celsius under pressure.

14. The method as claimed in claim 1, wherein the vacuum molding is to seal the composite material which is applied with a pressure between 0 to 100 atmospheric pressure.

15. The method as claimed in claim 1, wherein the vacuum molding is to seal the composite material by a seal member.

16. A shell with brightened surface is made by an uncured composite material which includes a matrix resin and at least one fiber.
